(19) United States
(12) Patent Application Publication
(10) Pub. No.: US 2026/0014677 A1
(43) Pub. Date: Jan. 15, 2026

(54) WRENCH ASSEMBLY, FUNCTIONAL MODULE, AND COMMUNICATION DEVICE

(71) Applicant: RUIJIE NETWORKS CO., LTD., Fujian (CN)

(72) Inventor: Dingkui HUA, Fujian (CN)

(73) Assignee: RUIJIE NETWORKS CO., LTD., Fujian (CN)

(21) Appl. No.: 19/332,090

(22) Filed: Sep. 18, 2025

Related U.S. Application Data
(63) Continuation of application No. PCT/CN2024/085687, filed on Apr. 2, 2024.

(30) Foreign Application Priority Data
Apr. 4, 2023 (CN) 202320726209.0

(51) Int. Cl. B25B 13/48

(52) U.S. Cl. CPC B25B 13/48

(57) ABSTRACT

Exemplary embodiments disclose a wrench assembly, a functional module and a communication device. The wrench assembly is fixedly disposed on a functional module and includes: a wrench base, including: a wrench base body; and a rotating shaft fixedly disposed on the wrench base body; a wrench, including: a grip portion; and a hook portion fixedly disposed at one end of the grip portion, where the hook portion is rotatably connected to the wrench base body via the rotating shaft; and a torsion spring sleeved on the rotating shaft and including: a main body portion; a first torsion arm extending from the main body portion and acting on the wrench; and a second torsion arm extending from the main body portion and acting on the wrench base body; where when the torsion spring is in a natural state, the grip portion is parallel to a front panel of the functional module.

### CROSS-REFERENCE TO RELATED APPLICATIONS

This application is a continuation of International Application No. PCT/CN2024/085687, filed on Apr. 2, 2024, which claims priority to Chinese Patent Application No. 202320726209.0, filed with the China National Intellectual Property Administration on Apr. 4, 2023 and entitled “WRENCH ASSEMBLY, FUNCTIONAL MODULE, AND COMMUNICATION DEVICE”, both of which are incorporated herein by reference in its entirety.

### TECHNICAL FIELD

This application relates to the field of communication device technology, and in particular, to a wrench assembly, a functional module, and a communication device.

### BACKGROUND

Communication devices typically include a chassis and a functional module (such as a line card module or a control module) disposed within the chassis, where a connector of the functional module is connected to a corresponding connector in the chassis. The functional module needs to be inserted into or removed from the chassis, however, during the process of inserting or removing the functional module in or from the chassis, a considerable force is required to achieve engagement or disengagement between the connector of the functional module and the corresponding connector in the chassis, resulting in a high workload for operators.

### SUMMARY

Exemplary embodiments of this application provide a wrench assembly, a functional module, and a communication device.

A first aspect of this application provides a wrench assembly, fixedly disposed on a functional module, including: a wrench base, a wrench, and a torsion spring. The wrench base includes: a wrench base body; and a rotating shaft fixedly disposed on the wrench base body. The wrench includes: a grip portion; and a hook portion fixedly disposed at one end of the grip portion, where the hook portion is rotatably connected to the wrench base body via the rotating shaft. The torsion spring is sleeved on the rotating shaft and includes: a main body portion; a first torsion arm extending from the main body portion and acting on the wrench; and a second torsion arm extending from the main body portion and acting on the wrench base body; where when the torsion spring is in a natural state, the grip portion is parallel to a front panel of the functional module.

When the wrench assembly provided in this application is used, the wrench base is mounted on the front panel of the functional module, and through cooperation between the hook portion of the wrench and a locking hole of a locking base on a chassis, insertion and removal of the functional module can be assisted, so that the insertion and removal of the functional module are more labor-saving. Meanwhile, when the torsion spring is in a natural state, the grip portion is parallel to the front panel of the functional module, facilitating the application of force by an operator during the insertion and removal operations of the functional module.

In an embodiment, the wrench base body has two support arms spaced apart and oppositely disposed, the rotating shaft connects the two support arms, and an axis of the rotating shaft is parallel to a line connecting the two support arms; and the torsion spring and the hook portion are sequentially disposed along an axial direction of the rotating shaft.

In an embodiment, one support arm of the two support arms is provided with a receiving cavity, and the torsion spring body and the second torsion arm are located in the receiving cavity.

In an embodiment, the receiving cavity includes a first cavity and a second cavity communicating with the first cavity, the main body portion of the torsion spring is located in the first cavity, and the second torsion arm is located in the second cavity, where the second cavity is located at a side of the first cavity away from the wrench.

In an embodiment, a height of the second cavity in an extension direction of the axis of the rotating shaft is greater than or equal to an outer diameter of the first torsion arm.

In an embodiment, the receiving cavity is provided with an opening at a side away from the grip portion, and the first torsion arm extends beyond the receiving cavity from the opening to act on the wrench.

In an embodiment, an end of the grip portion facing the hook portion is provided with an abutment portion, a height of the abutment portion is greater than a spacing between the two support arms, the abutment portion includes an abutment surface, and the abutment surface is configured to form a fulcrum of a lever mechanism for removal of a functional module body of the functional module.

In an embodiment, the abutment surface is provided with a limiting groove, and the first torsion arm is located in the limiting groove to act on the grip portion.

In an embodiment, a height of the limiting groove in an extension direction of the axis of the rotating shaft is greater than or equal to an outer diameter of the second torsion arm.

In an embodiment, when the wrench is rotated toward an outer side of a chassis, the abutment surface abuts against a side surface of a locking base of the chassis to remove the functional module body of the functional module.

In an embodiment, the grip portion is in a long strip shape and provided with a grip groove at a side facing the front panel of the functional module.

In an embodiment, the wrench base body has a connection portion configured to connect with the front panel, and the connection portion is provided with at least two first through holes.

In an embodiment, the wrench assembly further includes a screw, the wrench base body is provided with a second through hole, and the screw passes through the second through hole to be capable of connecting with the chassis.

In an embodiment, the wrench assembly further includes an elastic piece, and the elastic piece is sleeved on a shank portion of the screw and located between a head portion of the screw and the second through hole.

A second aspect of this application further provides a functional module, including a functional module body and any wrench assembly provided in the foregoing solutions, where the functional module body has a front panel, and the wrench base is fixedly disposed on the front panel.

In this solution, the above wrench assembly is used. In this case, at least the technical effects achievable by the wrench assembly can be attained, to be specific, through the cooperation between the hook portion of the wrench and the locking hole of the locking base of the chassis, the insertion and removal of the functional module can be assisted, so that the insertion and removal of the functional module are more labor-saving. Meanwhile, when the torsion spring is in a natural state, the grip portion is parallel to the front panel of the functional module, facilitating the application of force by an operator during the insertion and removal operations of the functional module.

A third aspect of this application further provides a communication device, including a chassis and the functional module provided in the foregoing solutions, where the chassis is provided with a locking base in a one-to-one correspondence with the functional module, and each locking base is provided with a locking hole; and the wrench can cooperate with the corresponding locking hole to assist in insertion and removal of the functional module in the chassis.

The above functional module is used. In this case, at least the technical effects achievable by the functional module can be attained, to be specific, through the cooperation between the hook portion of the wrench and the locking hole of the locking base of the chassis, the insertion and removal of the functional module can be assisted, so that the insertion and removal of the functional module are more labor-saving. Meanwhile, when the torsion spring is in a natural state, the grip portion is parallel to the front panel of the functional module, facilitating the application of force by an operator during the insertion and removal operations of the functional module.

### BRIEF DESCRIPTION OF DRAWINGS

To more clearly illustrate the technical solutions of the embodiments of this application, the drawings for the embodiments of this application are briefly described below. It is clear that the drawings introduced below are only some embodiments of this application, and those skilled in the art can obtain other drawings based on these drawings without creative effort.

FIG. 1 is a schematic structural diagram of a wrench assembly according to an embodiment of this application, where a locking base on a chassis is also shown.

FIG. 2 is an exploded view of the wrench assembly shown in FIG. 1.

FIG. 3 is a schematic structural diagram of a wrench in the wrench assembly shown in FIG. 1.

FIG. 4 is a schematic structural diagram of a communication device according to an embodiment of this application.

### DESCRIPTION OF REFERENCE SIGNS

1: wrench base; 11: wrench base body; 111: support arm; 112: receiving cavity; 112a: first cavity; 112b: second cavity; 113: second through hole; 12: rotating shaft; 13: connection portion; 131: first through hole; 2: wrench; 21: grip portion; 211: limiting groove; 212: grip groove; 22: hook portion; 23: abutment portion; 231: abutment surface; 3: torsion spring; 31: torsion arm; 31a: first torsion arm; 31b: second torsion arm; 32: main body portion; 4: screw; 41: shank portion; 42: head portion; 5: elastic piece; 100: front panel; 200: chassis; 210: locking base; 2101: locking hole; and 2102: side surface.

### DESCRIPTION OF EMBODIMENTS

The technical solutions in the embodiments of this application are clearly and thoroughly described below with reference to the drawings in the embodiments of this application. It is clear that the described embodiments are only some but not all embodiments of this application. Based on the embodiments of this application, all other embodiments obtained by those skilled in the art without creative effort fall within the protection scope of this application.

Hereinafter, the terms “first” and “second” are used for descriptive purposes only and cannot be understood as an indication or implication of relative importance or implicit indication of a quantity of indicated technical features. Thus, a feature defined with “first” or “second” may explicitly or implicitly include one or more of such features. In the description of the embodiments of this application, unless otherwise specified, “a plurality of” means two or more.

In the case of using “include”, “have”, and “contain” described in this application, another component may be added unless explicit restrictive terms such as “only” or “consist of” are used. Unless mentioned to the contrary, a term in singular form may include plural form and cannot be understood as being limited to one in number.

In this application, unless otherwise defined in the context, if an element is referred to as being “fixedly disposed on”, “disposed on”, or “mounted on” another element, it may be fixedly disposed on, disposed on, or mounted on the another element directly or through an intervening element. If an element is considered to be “connected” to another element, it may be connected to the another element directly or through an intervening element. If present, the directional terms “vertical”, “horizontal”, “upper”, “lower”, “left”, “right”, and similar expressions used in this application are for the purpose of illustrating positional relationships between elements and are not intended to impose specific limitations.

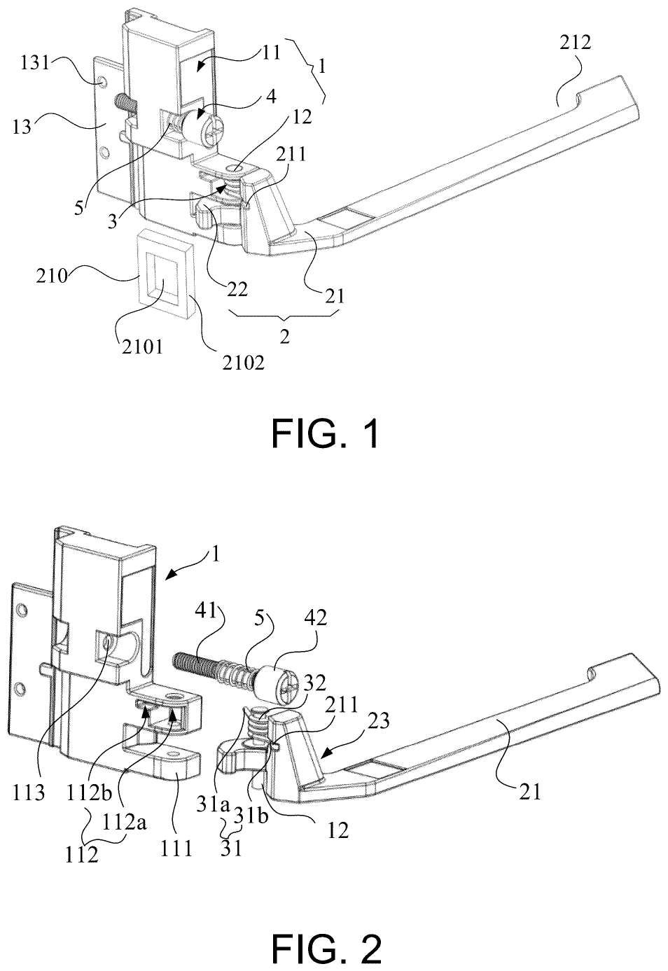

As shown in FIG. 1 and FIG. 2, a wrench assembly provided in this embodiment includes a wrench base 1, a wrench 2, and a torsion spring 3, where the wrench 2 includes a grip portion 21 and a hook portion 22 fixedly disposed at one end of the grip portion 21.

The wrench base 1 includes a wrench base body 11 and a rotating shaft 12 fixedly disposed on the wrench base body 11, and the hook portion 22 is rotatably disposed on the wrench base body 11 via the rotating shaft 12.

The torsion spring 3 is sleeved on the rotating shaft 12. The torsion spring 3 includes a main body portion 32, a first torsion arm 31a, and a second torsion arm 31b. The second torsion arm 31b of the torsion spring 3 acts on the wrench 2, and the first torsion arm 31a of the torsion spring 3 acts on the wrench base body 11, so that when the torsion spring 3 is in a natural state, the grip portion 21 can be parallel to a front panel 100 of a functional module.

When the wrench assembly provided in this embodiment is used, the wrench base 1 is mounted on the front panel 100 of the functional module, and through cooperation between the hook portion 22 of the wrench 2 and a locking hole 2101 of a locking base 210 on a chassis 200, insertion and removal of the functional module may be assisted, so that the insertion and removal of the functional module are more labor-saving.

Meanwhile, when the torsion spring 3 is in a natural state, the grip portion 21 is parallel to the front panel 100 of the functional module, facilitating application of force by an operator during insertion and removal operations of the functional module.

It should be noted that in this embodiment, a size and material of the torsion spring 3 are not limited.

With continued reference to FIG. 1 and FIG. 2, for a specific configuration of the wrench base body 11, the wrench base body 11 may have two support arms 111 spaced apart and oppositely disposed. The rotating shaft 12 may be disposed between the two support arms 111. One end of the rotating shaft 12 may be rotatably connected to the upper support arm 111, and another end of the rotating shaft 12 may be rotatably connected to the lower support arm 111. A rotation axis of the rotating shaft 12 may be parallel to a vertical line connecting the two support arms 111. The torsion spring 3 and the hook portion 22 are sequentially arranged along an axial direction of the rotating shaft 12.

In a possible implementation, one support arm 111 of the two support arms 111 is provided with a receiving cavity 112, the torsion spring 3 is located in the receiving cavity 112, one torsion arm 31b of the torsion spring 3 extends beyond the receiving cavity 112 and acts on the wrench 2, and the other torsion arm 31a of the torsion spring 3 acts on the wrench base body 11.

Take a state and an orientation shown in FIG. 1 as an example. An end of the receiving cavity 112 away from the grip portion 21 of the wrench 2 is open, and the torsion arm 31b of the torsion spring 3 acting on the wrench 2 extends beyond the receiving cavity 112 from the open end of the receiving cavity 112 and acts on the wrench 2. The receiving cavity 112 includes a first cavity 112a and a second cavity 112b communicating with the first cavity 112a. Along the axial direction of the torsion spring 3, the second cavity is located at an end of the torsion spring 3 away from the torsion arm 31 acting on the wrench 2. Meanwhile, the second cavity is located at a side of the first cavity away from the wrench 2. The main body portion 32 of the torsion spring 3 is disposed in the first cavity 112a, and the torsion arm 31a of the torsion spring 3 acting on the wrench base 1 is located in the second cavity 112b.

In some embodiments, a height of the second cavity 112b in an extension direction of the axis of the rotating shaft 12 may be greater than or equal to an outer diameter of the first torsion arm 31a. In some embodiments, the height of the second cavity 112b may be slightly greater than the outer diameter of the first torsion arm 31a, thereby limiting movement of the first torsion arm 31a in a height direction to ensure stability of the torsion spring.

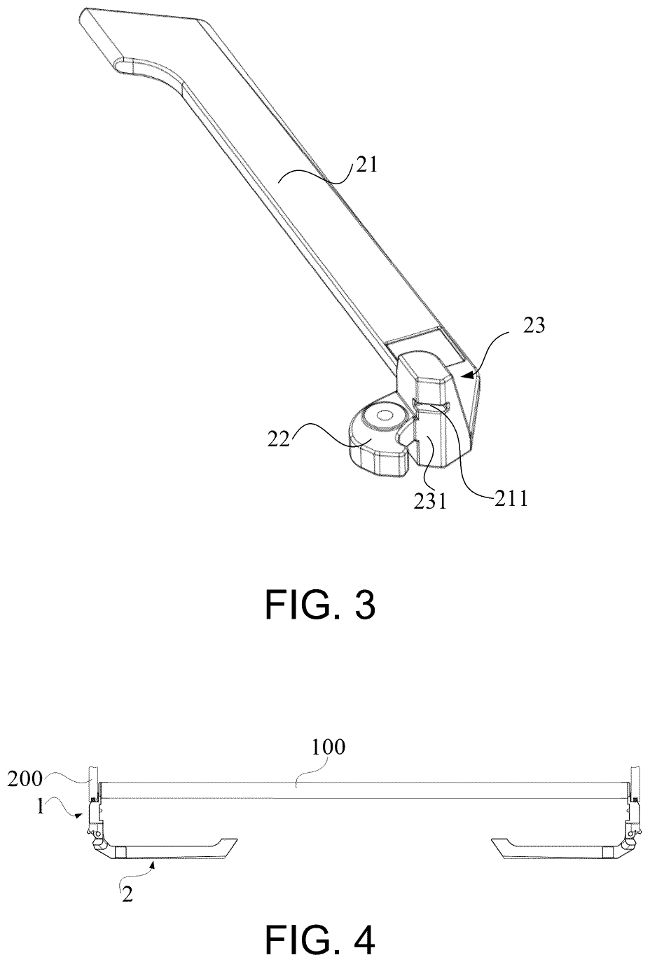

As shown in FIG. 2 and FIG. 3, an end of the grip portion 21 facing the hook portion 22 is provided with an abutment portion 23, a height of the abutment portion 23 is greater than a spacing between the two support arms 111. The abutment portion 23 includes an abutment surface 231, so that when the wrench is rotated to remove a functional module body from the chassis (in a clockwise rotating direction of the grip portion 21 with respect to the abutment portion 23 in FIG. 2), the abutment surface 231 abuts against a side surface 2102 of the locking base 210, forming a fulcrum of a lever mechanism to assist in removal of the functional module body.

With continued reference to FIG. 2 and FIG. 3, a limiting groove 211 is formed on the abutment portion 23, facing the hook portion 22, of the grip portion 21 of the wrench 2, and a corresponding torsion arm 31 of the torsion spring 3 is located in the limiting groove 211 to facilitate positioning of the torsion spring 3, thereby enabling the torsion spring 3 to function more stably. The end, facing the hook portion 22, of the grip portion 21 of the wrench 2 is an end of the grip portion 21 close to the hook portion 22.

Similarly, a height of the limiting groove 211 in the extension direction of the axis of the rotating shaft 12 may be greater than or equal to an outer diameter of the second torsion arm 31b. In some embodiments, the height of the second cavity 112b may be slightly greater than the outer diameter of the first torsion arm 31a, thereby limiting movement of the first torsion arm 31a in the height direction to ensure the stability of the torsion spring.

For a specific configuration of the grip portion 21, the grip portion 21 may be in a long strip shape and formed with a grip groove 212 to facilitate gripping by an operator during insertion and removal operations.

The wrench base body 11 may have a connection portion 13 configured to connect with the front panel 100 of the functional module, and the connection portion 13 may be provided with at least two first through holes 131 to facilitate the connection between the wrench base body 11 and the front panel 100 of the functional module. In this embodiment, a quantity of first through holes 131 on the connection portion 13 is not limited. For example, two, three, or four first through holes 131 may be arranged at intervals.

The wrench assembly may further include a screw 4. The wrench base body 11 may be formed with a second through hole 113, and the screw 4 passes through the second through hole 113 to be capable of connecting the wrench base body 11 with the chassis 200 of a communication device, thereby fixing the wrench assembly and the functional module body to the chassis 200 after the functional module is inserted in place, further ensuring the position of the functional module in the chassis 200.

The wrench assembly may further include an elastic piece 5, the elastic piece 5 is sleeved on a shank portion 41 of the screw 4 and located between a head portion 42 of the screw 4 and the second through hole 113. Thus, when the functional module needs to be removed, after the screw 4 is unscrewed by a certain length, the screw 4 may pop out under the action of the elastic piece 5, facilitating the removal of the functional module. For example, the elastic piece 5 may be a spring.

As shown in FIG. 4, a functional module provided in this embodiment includes a functional module body and the above wrench assembly, where the functional module body has a front panel 100, and the wrench base 1 is fixedly disposed on the front panel 100. In this solution, by using the above wrench assembly, at least the technical effects achievable by the wrench assembly can be attained, to be specific, through the cooperation between the hook portion 22 of the wrench 2 and the locking hole 2101 of the locking base 210 of the chassis 200, the insertion and removal of the functional module may be assisted, so that the insertion and removal of the functional module are more labor-saving. Meanwhile, when the torsion spring 3 is in a natural state, the grip portion 21 is parallel to the front panel 100 of the functional module, facilitating the application of force by an operator during the insertion and removal operations of the functional module.

As shown in FIG. 4, the front panel 100 of the functional module is provided with the above wrench assemblies at both ends in a length direction.

It should be noted that the functional module mentioned in this embodiment includes, but is not limited to, a line card module and a control module.

Referring to FIG. 1 and FIG. 4, a communication device provided in this embodiment includes a chassis 200 and the above functional module. The chassis 200 is provided with locking bases 210 in correspondence with the functional modules, and each locking base 210 is provided with a locking hole 2101. The wrench 2 can cooperate with the corresponding locking hole 2101 to assist in insertion and removal of the functional module in the chassis 200. Specifically, the hook portion 22 is locked in a locking hole 2101 of a corresponding locking base 210 on the chassis 200, and during rotation of the wrench 2, the cooperation between the hook portion 22 and the locking base 210 facilitates the insertion and removal of the functional module in the chassis 200. After the functional module is inserted into the chassis 200 with the wrench 2, the wrench 2 remains parallel to the front panel 100 of the functional module under the action of the torsion spring 3, where an insertion direction of the wrench 2 is a counterclockwise rotation direction of the grip portion 21 with respect to the abutment portion 23. After the functional module is removed from the chassis 200 with the wrench 2, the wrench 2 also remains parallel to the front panel 100 of the functional module under the action of the torsion spring 3, where the removal direction of the wrench 2 is a clockwise rotation direction of the grip portion 21 with respect to the abutment portion 23. In this solution, by using the above functional module is, at least the technical effects achievable by the functional module can be attained, to be specific, through the cooperation between the hook portion 22 of the wrench 2 and the locking hole 2101 of the locking base 210 of the chassis 200, the insertion and removal of the functional module may be assisted, so that the insertion and removal of the functional module are more labor-saving. Meanwhile, when the torsion spring 3 is in a natural state, the grip portion 21 is parallel to the front panel 100 of the functional module, facilitating the application of force by an operator during the insertion and removal operations of the functional module.

For example, one or more functional modules may be provided in the chassis 200.

It is clear that those skilled in the art can make various modifications and variations to this application without departing from the spirit and scope of this application. Thus, if these modifications and variations of this application fall within the scope of the claims of this application and their equivalent technologies, this application is intended to include these modifications and variations.

What is claimed is:

1. A wrench assembly, fixedly disposed on a functional module, comprising:
a wrench base, comprising:
a wrench base body; and
a rotating shaft fixedly disposed on the wrench base body;
a wrench, comprising:
a grip portion; and
a hook portion fixedly disposed at one end of the grip portion, wherein the hook portion is rotatably connected to the wrench base body via the rotating shaft; and
a torsion spring sleeved on the rotating shaft, comprising:
a main body portion;
a first torsion arm extending from the main body portion and acting on the wrench; and
a second torsion arm extending from the main body portion and acting on the wrench base body; wherein
when the torsion spring is in a natural state, the grip portion is parallel to a front panel of the functional module.

2. The wrench assembly according to claim 1, wherein the wrench base body has two support arms spaced apart and oppositely disposed, the rotating shaft connects the two support arms, and an axis of the rotating shaft is parallel to a line connecting the two support arms; and
the torsion spring and the hook portion are sequentially disposed along an axial direction of the rotating shaft.

3. The wrench assembly according to claim 2, wherein one support arm of the two support arms is provided with a receiving cavity, and the main body portion and the second torsion arm are located in the receiving cavity.

4. The wrench assembly according to claim 3, wherein the receiving cavity comprises a first cavity and a second cavity communicating with the first cavity, the main body portion of the torsion spring is located in the first cavity, and the first torsion arm is located in the second cavity, wherein the second cavity is located at a side of the first cavity away from the wrench.

5. The wrench assembly according to claim 4, wherein a height of the second cavity in an extension direction of the axis of the rotating shaft is greater than or equal to an outer diameter of the first torsion arm.

6. The wrench assembly according to claim 3, wherein the receiving cavity is provided with an opening at a side away from the grip portion, and the second torsion arm extends beyond the receiving cavity from the opening to act on the wrench.

7. The wrench assembly according to claim 6, wherein an end of the grip portion facing the hook portion is provided with an abutment portion, a height of the abutment portion is greater than a spacing between the two support arms, the abutment portion comprises an abutment surface, and the abutment surface is configured to form a fulcrum of a lever mechanism for removal of a functional module body of the functional module.

8. The wrench assembly according to claim 7, wherein the abutment surface is provided with a limiting groove, and the second torsion arm is located in the limiting groove to act on the grip portion.

9. The wrench assembly according to claim 8, wherein a height of the limiting groove in an extension direction of the axis of the rotating shaft is greater than or equal to an outer diameter of the second torsion arm.

10. The wrench assembly according to claim 8, wherein when the wrench is rotated toward an outer side of a chassis, the abutment surface abuts against a side surface of a locking base of the chassis to remove the functional module body of the functional module.

11. The wrench assembly according to claim 1, wherein the grip portion is in a long strip shape and provided with a grip groove at a side facing the front panel of the functional module.

12. The wrench assembly according to claim 1, wherein the wrench base body has a connection portion configured to connect with the front panel, and the connection portion is provided with at least two first through holes.

13. The wrench assembly according to claim 1, wherein the wrench assembly further comprises a screw, the wrench base body is provided with a second through hole, and the screw passes through the second through hole to be capable of connecting with a chassis.

14. The wrench assembly according to claim 13, wherein the wrench assembly further comprises an elastic piece, and the elastic piece is sleeved on a shank portion of the screw and located between a head portion of the screw and the second through hole.

15. A functional module, comprising a functional module body and the wrench assembly according to claim 1, wherein the functional module body has a front panel, and the wrench base is fixedly disposed on the front panel.

16. A communication device, comprising:
a chassis; and
at least one functional module according to claim 15; wherein
the chassis is provided with a locking base corresponding to the functional module, the locking base is provided with a locking hole, and the wrench is capable of cooperating with the locking hole to assist in insertion and removal of the functional module body in the chassis.
